(19) United States
(12) Patent Application Publication
(10) Pub. No.: US 2021/0081393 A1
(43) Pub. Date: Mar. 18, 2021

(54) UPDATING A DATABASE USING VALUES FROM AN INBOUND MESSAGE IN RESPONSE TO A PREVIOUS OUTBOUND MESSAGE

(71) Applicant: Oracle International Corporation, Redwood Shores, CA (US)

(72) Inventors: Jennifer Darmour, Seattle, WA (US); Loretta Marie Grande, Seattle, WA (US); Ronald Paul Lapurga Viernes, Seattle, WA (US); Jingyi Han, San Jose, CA (US); Nicole Santina Giovanetti, Rancho Cordova, CA (US); Jason Wong, Seattle, WA (US); Min Hye Kim, Newcastle, WA (US)

(73) Assignee: Oracle International Corporation, Redwood Shores, CA (US)

(21) Appl. No.: 17/018,257

(22) Filed: Sep. 11, 2020

Related U.S. Application Data
(60) Provisional application No. 62/900,568, filed on Sep. 15, 2019.

(51) Int. Cl. G06F 16/23; G06F 21/62; G06F 21/60; G06F 9/54

(52) U.S. Cl. CPC G06F 16/235; G06F 16/2379; G06F 9/542; G06F 21/604; G06F 21/6218

(57) ABSTRACT

A technique is described for updating a datastore using a value from an inbound transmission that corresponds to a prior outbound transmission. The outbound transmission and the inbound transmission may be associated with one another so that a system may extract a particular value from one or more of the transmissions. The extracted value may be used to update a datastore. A system may extract the particular value from an editable data object in the inbound transmission. A system may also compare a current value of a data object in a data store with an updated value and generate a notification or other transmission prior to extracting the value and updating the data store.

### RELATED APPLICATIONS; INCORPORATION BY REFERENCE

This application claims the benefit of U.S. Provisional Patent Application 62/900,568, filed Sep. 15, 2019, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to database computing environments. In particular, the present disclosure relates to updating a database using values detected in an inbound message transmitted in response to a prior outbound message.

### BACKGROUND

Any modern computer-based data storage may store a large number of values. A data storage may store values in various formats, such as in a database or data structure. For example, computer data may be stored as tables, each table comprising multiple rows and columns. The data storage may provide electronic access to the data, such as through the use of database management or programming software.

Frequent changes to the data in the data storage may occur over time. For example, the data storage users may electronically create, update, or delete multiple data values. Performing these changes may require specialized knowledge of the data storage. For example, a user may need to locate the portion of the data storage that requires an update. The user may need specific permissions to access the relevant data. The user may require special skills, such as knowledge of database programming functions, in order to properly update the data. When such changes must be made frequently and across many different data resources, the process may become resource-intensive, complex, and prone to error.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for extracting a value from an inbound transmission received in response to a prior outbound transmission and updating a datastore with the value, in accordance with one or more embodiments;

FIG. 3 illustrates an example set of operations updating a datastore with a value in response to determining whether one or both of an authorization level associated with a source of the inbound transmission and/or a source of the prior outbound transmission is sufficient for datastore updates using the operations illustrated in FIG. 2, in accordance with one or more embodiments;

FIG. 4 illustrates an example set of operations for updating a datastore with a value transmitted in an outbound transmission by extracting the value from the outbound transmission responsive to an inbound transmission verifying the value in the prior outbound transmission;

FIG. 5 illustrates an example set of operations for updating a datastore with a value received via an inbound transmission in response to first determining whether an authorization level associated with a source of the inbound transmission is sufficient for datastore updates, in accordance with one or more embodiments;

FIG. 6 illustrates an example set of operations for generating a response and/or a notification indicating that a value of a data object received via an inbound transmission is different than a currently stored value of the data object;

FIGS. 7-9 schematically illustrate example inbound and outbound transmissions that may be processed according to one or more of the example sets of operations illustrated in FIGS. 2-6 to update values in a datastore using one or both of an inbound transmission and/or an outbound transmission; and

FIG. 10 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. SYSTEM ARCHITECTURE
3. DATASTORE VALUE UPDATES EXTRACTED FROM ASSOCIATED INBOUND AND OUTBOUND TRANSMISSIONS
3.1 EXTRACTING A VALUE FROM AN INBOUND TRANSMISSION UPON IDENTIFYING A PRIOR OUTBOUND TRANSMISSION REQUESTING THE VALUE
3.2 EXTRACTING A VALUE FROM A PRIOR OUTBOUND TRANSMISSION UPON IDENTIFYING A VALUE VALIDATION IN AN INBOUND TRANSMISSION
3.3 EXTRACTING A VALUE FROM AN INBOUND TRANSMISSION UPON IDENTIFYING REQUIRED AUTHORIZATION LEVELS MET BY TRANSMISSION SOURCE(S)
4. GENERATING A NOTIFICATION UPON DETERMINING A DIFFERENCE IN A STORED VALUE AND A VALUE RECEIVED IN AN INBOUND TRANSMISSION
5. EXAMPLE EMBODIMENTS
6. COMPUTER NETWORKS AND CLOUD NETWORKS
7. MISCELLANEOUS; EXTENSIONS
8. HARDWARE OVERVIEW

### 1. GENERAL OVERVIEW

One or more embodiments include updating a datastore using a value from an inbound transmission, wherein the inbound transmission corresponds to a prior outbound transmission. The outbound transmission and the inbound transmission may be associated with one another using one or more common identifiers found in both of the inbound and outbound transmissions. Examples of common identifiers used to associate inbound and outbound transmissions with one another include a data object identifier, a parameter identifier, a transaction identifier, a contract identifier, or an identifier associated with the outbound transmission itself. Upon making the association between the inbound and outbound transmissions, a system may extract a particular value from one or more of the transmissions and subsequently use the value to update a datastore. In some examples, a system may extract the particular value from an editable data object in the inbound transmission. A system may also compare a current value of a data object in a data store with an updated value and generate a notification or other transmission prior to extracting the value and updating the data store.

One or more embodiments described in this Specification and/or recited in the claims may not be included in this General Overview section.

### 2. ARCHITECTURAL OVERVIEW

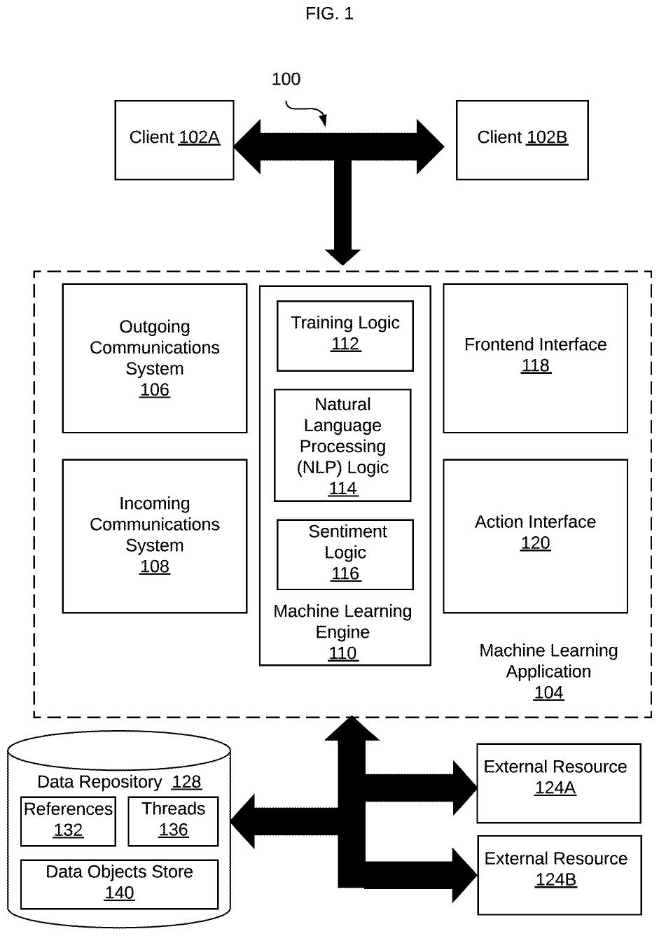

FIG. 1 illustrates a system 100 in accordance with one or more embodiments. As illustrated in FIG. 1, system 100 includes clients 102A, 102B, a machine learning (ML) application 104, a data repository 128 and external resources 124A, 124B. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In some examples, the clients 102A, 102B may be a web browser, mobile application, or other software application communicatively coupled to a network. In other examples, a client 102A, 102B may be associated with a human user (such as a system administrator) or associated with another application, such as a shell or client application. In some examples, a client 102A, 102B is an interface used for communication between systems (e.g., a datastore management system and an external source of an inbound transmission) or between operators (e.g., an external (from the system 100) supplier and an internal (to the system 100) supplier manager).

5

A client may interact with an embodiment of the machine learning application 104 that is instantiated as a cloud service using one or more communication protocols, such as HTTP and/or other communication protocols of the Internet Protocol (IP) suite. In other embodiments, in which ML application 104 may be instantiated as a local system (e.g., via an “on-premises” computer system), the clients 102A, 102B may be a desktop or other standalone application that may access the ML application 104.

The example ML application 104 illustrated in FIG. 1 includes an outgoing communications system 106, an incoming communications system 108, a machine learning engine 110, a frontend interface 118, and an action interface 120. In some embodiments, ML application 104 is a cloud service, such as a software-as-a-service (SaaS) or a web service. In other embodiments, the ML application 104 is operated on a dedicated system (e.g., in a private network, an “on-premises” computer system, a private distributed computer network system).

The outgoing communications system 106 and the incoming communication system 108 of the ML application 104 may, collectively, be configured to prepare, transmit, analyze and monitor outgoing and incoming transmissions and communications. The outgoing communications system 106 and the incoming communication system 108 may also communicate with other elements of the machine learning application 104, such as machine learning engine 110 and data repository 128, to analyze the content of incoming and outgoing communications to accomplish the analyses described below. Specific examples of the outgoing communication system 106 may include an electronic messaging client (e.g., a text messaging and/or email client) or a communication interface in a computing application configured to execute other functions (e.g., supply management functions).

In particular, the outgoing communications system 106 may be configured to prepare and transmit communications (alternately and equivalently referred to as “transmissions”) using generic electronic communications techniques and protocols that include email, text messaging (SMS, MMS), fax, scanned images processed using optical character recognition (OCR), or even digital transcriptions of verbal communications. In some examples, the outgoing communications system 106 may use techniques and protocols to prepare and/or transmit electronic communications via electronic communication channels that are configured and dedicated to communications between particular entities or for a particular purpose. Examples of dedicated communication channels include digital applications, websites, or systems that are configured to manage purchase orders, supply agreements, contracts, and the associated logistical and financial transactions associated with the various orders, agreements, and contracts that prescribe the boundaries of a buyer-supplier relationship.

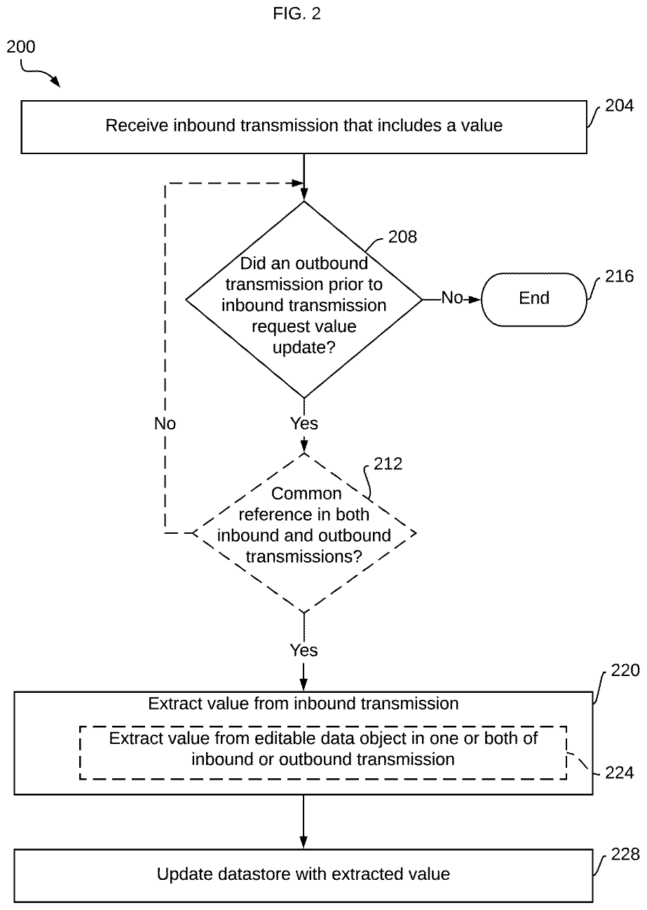

Also, the outgoing communication system 106 may be in communication with other elements of the machine learning application 104. The inter-operation of the outgoing communication system 106 with, for example, the machine learning engine 110 and the data repository 128 enables the outgoing communication system 106 to execute the analyses described below in the context of FIGS. 2-9.

The incoming communication system 108 may be configured to receive and analyze incoming transmissions. The incoming communication system 108 may use one or more of the transmission protocols and/or techniques described above in the context of the outgoing communication system 106 to analyze incoming transmissions. Also, as with the outgoing communication system 106, the incoming communication system 108 is in communication with other elements of the machine learning application 104. The inter-operation of the incoming communication system 108 with, for example, the machine learning engine 110 and the data repository 128 enables the incoming communication system 108 to execute the analyses described below in the context of FIGS. 2-9.

The outgoing communications system 106 and the incoming communication system 108 collectively may provide an integrated communication analysis and transmission system that improves the convenience of communication between a supplier and a purchaser. In one example, the system 106 and 108 may include functions that enable communicating parties to conveniently include and/or reference data objects related to the communications. For example, because the outgoing communications system 106 and the incoming communication system 108 inter-operate with the data repository 128, the systems 106, 108 may identify and refer to stored data items related to the subject of various transmissions. In one illustration, two parties to a contract may correspond regarding a particular term of a contract that has been electronically rendered and stored in the data repository 128. This correspondence may be assisted by including a data object from the data repository that includes information related to the particular term of the contract. Including the data object associated with the particular term that is the subject of the correspondence may improve the clarity and efficiency of the correspondence and thereby improve the speed with which question or issues are resolved by the correspondence. In some examples, communicating parties may engage the functions of the outgoing communications system 106 and the incoming communication system 108 via, for example, one or more clients 102A, 102B.

One or both of the outgoing communications system 106 and the incoming communication system 108 may query the data repository 128 (e.g., via an API associated with the action interface 120) for references (also termed “identifiers”) associated with data objects, terms associated with contracts or supply agreements, and stored communication threads. Similarly, one or both of the outgoing communications system 106 and the incoming communication system 108 may store in the data repository (e.g., via an API associated with the action interface 120) communications and communication threads, updated values associated with data objects, and any other representation of communications or data extracted from communications.

The machine learning engine 110, which includes training logic 112, natural language processing logic 114, and sentiment logic 116, may be trained to identify associations between communications and data objects, select data objects for placement in communications, identify values in communications that may be used to update data objects, and otherwise analyze communications to determine whether a data object may properly be updated with a particular value extracted from one or both of an inbound transmission and/or an outbound transmission.

In some examples, one or more elements of the machine learning engine 110 may use a machine learning algorithm to identify the patterns described above. A machine learning algorithm is an algorithm that can be iterated to learn a target model f that best maps a set of input variables to an output variable, using a set of training data. A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

In an embodiment, a set of training data includes datasets and associated labels. The datasets are associated with input variables (e.g., reference numbers such as transmission identifiers, parameter names, parameter identifiers, email addresses, key words in a product description, source and destination addresses for communications) for the target model f. The associated labels are associated with the output variable (e.g., data object identifiers and corresponding parameters) of the target model f. The training data may be updated based on, for example, feedback on the accuracy of the current target model f. Updated training data is fed back into the machine learning algorithm, which in turn updates the target model f.

A machine learning algorithm generates a target model f such that the target model f best fits the datasets of training data to the labels of the training data. Additionally or alternatively, a machine learning algorithm generates a target model f such that when the target model f is applied to the datasets of the training data, a maximum number of results determined by the target model f matches the labels of the training data.

In an embodiment, a machine learning algorithm can be iterated to learn a similarity determination model. In an embodiment, a set of training data includes product identifiers, product descriptions, and/or data object identifiers. These data may be associated with labels, indicating a similarity score so that different types of data (e.g., a product identifier and a data object identifier) may be associated with one another. The similarity score may be a binary value (0 and 1), indicating a classification as to whether or not parameters (e.g., a product identifier, a product description, a data object identifier) may be associated with one another. Alternatively, the similarity score may assume one of more than two values, indicating a degree or strength of the association.

More specifically, in the embodiment of the system 100, training logic 112 of the ML engine 110 may be trained by analyzing transmissions in which one or more reference identifiers are present. Using the training logic 112 to identify reference identifiers in transmissions and associating related transmissions with one another enables the machine learning application 104 (and the communication systems 106, 108) to link or otherwise associate related transmissions into a thread. Similarly, the training logic 112 may be used to train the ML engine 110 to use reference numbers, product descriptions, and/or source and destination addresses to determine which data objects in a data store to update and whether the update is authorized to be made. In some examples, the associations between reference numbers, product descriptions, and/or source and destination addresses, once established by the training logic 112, may be stored in the data repository 128.

The training logic 112 may identify and learn these patterns by generating feature vectors of a training corpus of communications and electronically rendered resources related to the communications (e.g., agreements, supply contracts, inbound and outbound transmissions). That is, the ML engine 110 may include logic to identify and extract features, such as account identifiers, supplier identifiers, product identifiers, prices, order dates, scheduled fulfilment dates, product descriptions, and quantities from various resources.

The natural language processing (NLP) logic 114 and the sentiment logic 116 may be used to identify and interpret the meaning of communications transmitted from and to the systems 106, 108 (respectively). The NLP logic 114 may use any of a variety of NLP techniques to interpret the meaning of communications. Examples of feature vectors commonly used in NLP include, but are not limited to term frequency-inverse document frequency (TF-IDF), or term frequency (TF) count vectors.

The NLP logic 114 may include logic to generate a vocabulary, extract feature vectors from the various different types of information stored in the data repository 128, and execute topic modeling analyses to more accurately analyze inbound and outbound transmissions. Examples of topic modeling algorithms include, but are not limited to, latent Dirichlet allocation (LDA) or correlated topic modeling (CTM). It will be appreciated that other types of vectors may be used in probabilistic analyses of latent topics. The topic extraction logic of the NLP logic 114 may identify products, product types, and/or topics of conversation in the various transmissions (e.g., disputes regarding agreements, shipments, pricing, etc., and the satisfactory resolution thereof). In some examples, topic modeling may also include training the training logic 112 using a set of topics as determined for a corpus of content. This may thus provide a distribution for each topic over a vocabulary of terms (e.g., words, images) generated from the corpus of content.

The sentiment logic 116 may be trained to identify a sentiment contained within any incoming or outgoing transmissions and/or within a communication thread of one or more associated incoming and outgoing transmissions. For example, using NLP processing techniques as well as statistical analyses and neural networks, the sentiment of one or more communications may be identified, thereby improving the operation of the system. For example, in cooperation with other elements of the system 100 and the ML analysis engine 110, sentiment logic 116 may identify a sentiment of communications as adversarial, collaborative, questioning, definitive (i.e., responsive to a question), as well as any of a variety of other sentiments. The determined sentiments may be used, in turn, to facilitate the execution of the various techniques described below.

The frontend interface 118 manages interactions between ML application 104 and clients 102A, 102B. For example, a client may submit requests to perform various functions and view results through frontend interface 118. In some embodiments, frontend interface 118 is a presentation tier in a multitier application. Frontend interface 118 may process requests received from clients, such as clients 102A, 102B, and translate results from other application tiers into a format that may be understood or processed by the clients. Frontend interface 118 may be configured to render user interface elements and receive input via user interface elements. For example, frontend interface 118 may generate webpages and/or other graphical user interface (GUI) objects. Client applications, such as web browsers, may access and render interactive displays in accordance with protocols of the internet protocol (IP) suite. Additionally or alternatively, frontend interface 118 may provide other types of user interfaces comprising hardware and/or software configured to facilitate communications between a user and the application. Example interfaces include, but are not limited to, GUIs, web interfaces, command line interfaces (CLIs), haptic interfaces, and voice command interfaces. Example user interface elements include, but are not limited to, checkboxes, radio buttons, dropdown lists, list boxes, buttons, toggles, text fields, date and time selectors, command lines, sliders, pages, and forms.

The action interface 120 action interface 120 provides an interface for executing actions using computing resources, such as external resources 124A, 124B. Action interface 120 may include an API, CLI, or other interfaces for invoking functions to execute actions. One or more of these functions may be provided through cloud services or other applications, which may be external to ML application 104. For example, one or more components of system 100 may invoke an API to access reference values, communication threads, and/or data objects stored in the data repository 128. In another example, one or more components of system 100 may invoke an API to access or communicate with different components of the system 100.

In some embodiments, external resources 124A, 124B are network services that are external to ML application 104. Example cloud services may include, but are not limited to, social media platforms, email services, short messaging services, enterprise management systems, verbal communication systems (e.g., internet based voice communications, text chat communications, POTS communications systems) and other cloud applications. Action interface 120 may serve as an API endpoint for invoking a cloud service. For example, action interface 120 may generate outbound requests that conform to protocols ingestible by external resources 124A, 124B. Action interface 120 may process and translate inbound requests to allow for further processing by other components of ML engine 110. Action interface 120 may store, negotiate, and/or otherwise manage authentication information for accessing external resources 124A, 124B. Example authentication information may include, but is not limited to, digital certificates, cryptographic keys, usernames, and passwords. Action interface 120 may include authentication information in the requests to invoke functions provided through external resources 124A, 124B.

In one or more embodiments, the system 100 may include or more data repositories 128. A data repository is any type of storage unit and/or device (e.g., a file system, database, collection of tables, or any other storage mechanism) for storing data. Further, the data repository may include multiple different storage units and/or devices. The multiple different storage units and/or devices may or may not be of the same type or located at the same physical site.

A data repository, such as the data repository 128 shown, may be implemented or may execute on the same computing system as the machine learning application 104. The data repository 128 may be communicatively coupled to the machine learning application 104 via a direct connection or via a network.

The example data repository 128 includes example data partitions 132, 136, 140 that store references and/or identifiers in reference store 132, communication threads in thread store 136, and data objects in a data object store 140. Storing these data enables the other elements of the machine learning application 104 to identify data objects and corresponding parameters to be updated based on transmissions into and out of the systems 106, 108.

For example, reference numbers stored in the references partition 132 may include various identifiers used to locate and/or cross-reference transmissions, data objects, and communication transmissions with one another. Examples of reference numbers include, but are not limited to, part or product identifiers, agreement (e.g., supply agreement, contract) identifiers, purchase order identifiers, communication identifiers, correspondent identifiers (e.g., a supplier name or supplier identifier), among others. The threads partition 136 may be used to store (or otherwise associate together) a series of multiple incoming and/or outgoing transmissions that the system identifies as related by a particular issue, a particular product reference, an agreement identifier (e.g., a contract number or purchase order number) or other common attribute.

The data objects store 140 may store data objects that are electronically stored representations of agreements, contracts, or other business objects that include parameters and corresponding values, the latter of which may be updated according to the techniques described below. In one illustration, an example system may store supply agreements that are electronically rendered into a plurality of data objects. In this example, the system may also store identifying part numbers associated with the supply agreements, and track the financial transaction, inventory levels, and shipment information (e.g., ship dates, tracking information, receipt dates) associated with the supply agreements stored in the data objects store 140.

Additional embodiments and/or examples relating to computer networks are described below in Section 6, titled “Computer Networks and Cloud Networks.”

In one or more embodiments, the various elements of the system 100 refer to hardware and/or software configured to perform operations described herein. Examples of operations for using the machine learning application 104 to update a datastore in response to an incoming transmission and a prior outbound transmission are described below with reference to FIGS. 2-9.

In an embodiment, the system 100, including the machine learning application 104, are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

In one or more embodiments, the term “interface” refers to hardware and/or software configured to facilitate communications between digital devices or a user and a heterogenous fulfillment system. An interface may render user interface elements and receive input via user interface elements. Examples of interfaces include those indicated above in the context of system 100.

In an embodiment, different components of example interfaces may be specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). In some examples, interfaces may be specified in one or more other languages, such as Java, C, or C++.

### 3. SELECTING A TAG FOR A CONTENT ITEM BASED AT LEAST ON USER DATA

The examples described in this Section 3.0 are directed to automatically updating a value (e.g., of a parameter) stored in a datastore in response to both an outbound transmission and an associated inbound transmission. Using both an outbound and inbound transmissions (or multiples of each, which may be collectively referred to as a communication or transmission “thread”) provides a number of advantages and efficiencies. For example, relying solely on an inbound transmission to update a datastore (or more generally, as a source of information to be used or processed by a system) exposes the datastore to a risk of implementing unverified or inaccurate data, unauthorized access, or malicious acts (e.g., malware, intentionally inaccurate data). These risks to the integrity of the stored data and the operation of the system as a whole are reduced by, as described herein, identifying an outbound email requesting the value (or data) that may act as a validation or authorization of updates made to the datastore by the inbound transmission. In some examples, the system may use authorization characteristics associated with one or both of the inbound and/or outbound transmissions as a precondition for datastore updates. Specific example embodiments are described in detail in the following Sections 3.1 to 3.4.

### 3.1 EXTRACTING A VALUE FROM AN INBOUND TRANSMISSION UPON IDENTIFYING A PRIOR OUTBOUND TRANSMISSION REQUESTING THE VALUE

FIG. 2 illustrates an example set of operations for extracting a value from an inbound transmission in response to identifying that the inbound transmission corresponds to a prior outbound transmission that requests the value, in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

The example set of operations, presented as method 200, begins by receiving an inbound transmission that includes a value (operation 204). In many of the examples described below, the value in the inbound transmission corresponds to a field (or parameter) value that is stored in a datastore. In some examples, the field corresponding to the value may be expressly identified in the inbound transmission, although this is not required. Other examples of techniques by which the system may identify a field corresponding to the updated value are described below.

Example transmission types may be any type of electronic transmission that the systems described herein are capable of analyzing using natural language process, sentiment analysis, and machine learning. One example of a transmission includes that of electronic communications prepared using electronic mail (email) systems and transmitted via the TCP/IP protocol.

In another example, specialized communication channels that facilitate communication using HTTP and/or REST protocols may also be used. A specific illustration of this type of electronic transmission is that of a dedicated website that includes electronic communication functions along with other system functions. This type of communication system was presented above in the context of FIG. 1 as an example system configured to monitor, document, and manage financial and logistical aspects of a buyer/supplier relationship. This type of communication system may be particularly convenient by enabling reference to supply agreements, purchase orders, financial transactions, inventory status, shipment status, and other conditions that are likely to be discussed and analyzed by a buyer and supplier. For example, this type of integrated system may enable linking, embedding, attaching or otherwise communicating information from a datastore via an electronic communication.

In some examples, regardless of the communication system or protocol used, a data object from a data store may be linked, embedded, attached, or otherwise accessed via one or both of the inbound and/or outbound transmissions. The data object may include field names and/or values that are the subject of the transmission(s). For example, one or more of the inbound and/or outbound transmissions may request and/or provide a verification of a value in the data object, a new value for the field thereby replacing a previous value, and/or an updated value for the field. In some examples the included data object may be editable, thereby enabling one of the correspondents to directly edit the data object with a new (or updated) field value. The system may then extract the new field value from the edited data object, thereby updating the field value in the data store without requiring further manual intervention.

In other embodiments, the system may use the machine learning and/or natural language processing techniques described above in the context of FIG. 1 to identify one or more of a field name and/or datastore data object to be updated by the value. For example, a trained machine learning system may identify various identifying references in one or more of the inbound and/or outbound transmissions. The references, once identified, may be used to identify a data object and/or field name to be updated in the datastore. For example, the machine learning system may identify, within the transmissions, one or more of contract identifiers, supply agreement identifiers, purchase order identifiers, part or service identifiers, and use these individually or in any combination to identify corresponding data objects and field names stored in the data store that may be updated according to the method 200.

In still other embodiments the system may use NLP techniques to identify these various identifiers. For example, the inbound and/or outbound transmissions may be tokenized, converted to feature vectors, and then compared to model vectors that identify patterns of references and/or data object names and field names. A similarity score analysis may be used to determine whether one or more of the inbound and/or outbound transmissions include identifying references and/or data object names and field names.

Upon receiving the inbound transmission that includes the value (operation 204), the system determines whether the inbound transmission was preceded by an outbound transmission requesting an update to the value (operation 208). In one example, the system may identify the prior outbound transmission using machine learning and/or NLP techniques, like those described above. For example, the system may use machine learning and/or NLP to identify a common reference, such as a purchase order identifier, contract identifier, part identifier, service identifier, or the like, that is common to both inbound and prior outbound transmissions 16 (operation 212). The system may supplement the operation 212 by also identifying transmission dates and times of communications that include the common reference so that contemporaneous communications are analyzed. Stale or out of date communications may optionally be disregarded or analyzed separately to improve accuracy of the analysis. If a common reference is identified, the method 200 may proceed to operations 216 or 220. However, if a common reference is not detected, the system may still use other techniques to identify a prior outbound transmission that corresponds to the received inbound transmission.

For example, the system may identify a prior outbound transmission that corresponds to an inbound transmission using NLP and/or a trained machine learning model (operation 208). The system may use these techniques to identify a transmission source, a transmission destination, transmission date/time, data object names, and/or field names within the received inbound transmission. The system may then use one or more of these identified aspects as search criteria to identify a stored version of the corresponding prior outbound transmission. The system may then use NLP (including topic analysis) and trained machine learning models to identify, within the identified prior outbound transmission, a request for the value (operation 208). The system may identify the request in the prior outgoing transmission by, for example, using a trained machine learning model to detect a field name and/or value and the corresponding request for the value in the outbound transmission. In an example, system may determine that a previously sent outbound message includes a request for a correction to a value. Illustrations of this correction request include: “this price is incorrect”, “the order quantity for widgets is incorrect, please fix” or “The invoice price of $30 does not match the contract price of $25.”

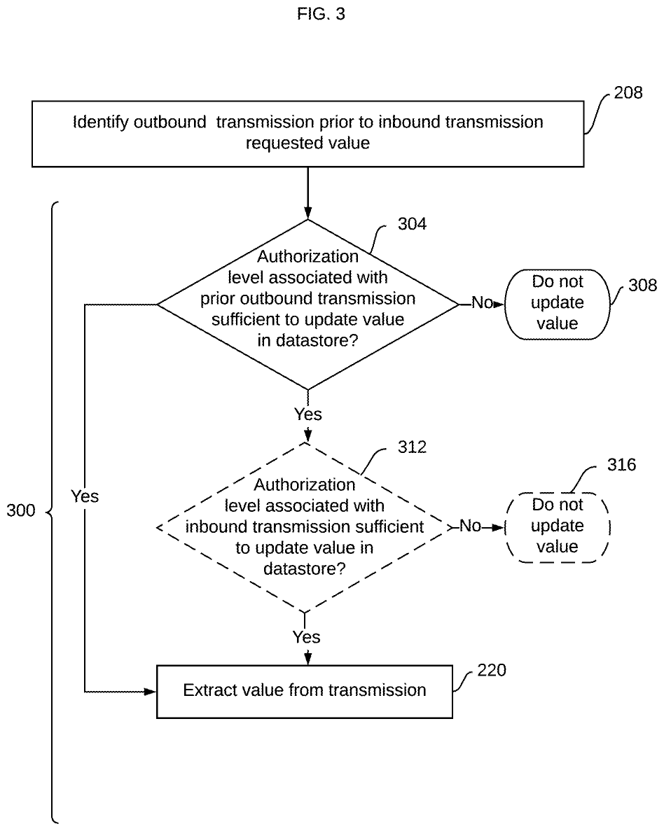

The identification of the prior outbound email that includes a request for the value update may optionally serve as security validation for the automatic update of the value in the datastore. This may, in some cases, prevent unauthorized, inaccurate, and/or malicious interactions with the datastore. FIG. 3 illustrates various optional operations of a method 300 that the system may use in coordination with elements of the method 200 to improve the security and integrity of datastore updates implemented through inbound and prior outbound transmissions.

Upon determining affirmatively that a prior outbound transmission requested a value provided by an inbound transmission (operation 208), the method 300 may determine whether an authorization level associated with prior outbound transmission is sufficient to update the value in the datastore (operation 304). For example, changes in a datastore may be limited to designated whitelisted groups within an organization, seniority levels within an organization, job roles, individual accounts, domain names, sub-domains within an internal network, or other similar criteria used for granting authority and/or permission to authorize datastore changes. Similarly, datastore changes may be prohibited for designated blacklisted groups, seniority levels, job roles, individual accounts, domain names, sub-domains within an internal network, or other similar criteria used for prohibiting authority and/or otherwise preventing datastore changes. Regardless, the system identifies or analyzes an origin of the prior outbound transmission (e.g., the account, the seniority or job function of the account from which the transmission was sent) to determine whether an authorization level is sufficient to permit changes to the data store.

The level of authorization required to permit these changes may be a function of the type of change. For example, the system may require a high level of authorization (e.g., vice president level or business unit director level) for transmissions resulting in changes to contractual terms. In a contrary example, the system may require a low level of authorization (e.g., manager, supply chain technician) for less significant changes to a datastore, such as updating a shipment quantity in an inventory tracking system datastore.

Regardless, if the minimum level of authorization is not met or exceeded, then the system terminates the process and the value is not updated (operation 308). If the authorization level of the prior outgoing transmission is met or exceeded, then the system may optionally determine whether an authorization level associated with a source of an inbound transmission is sufficient to update a value in a datastore (operation 312). Analogous to the operation 304, the system may identify a source of the inbound transmission, such as the domain, entity, and/or account from which it originated as well as any correlated characteristics (e.g., presence of an identified domain, entity, and/or account on a whitelist or blacklist). If the characteristics of the inbound email are not associated with an authorization level that meets or exceeds an authorization level needed to make datastore changes, then the value is not updated (operation 316). However, as with the operation 304, if the authorization level is met then the value can be extracted according to the operation 220, described below.

18

Returning to FIG. 2 and the method 200, if the system does not identify a prior outbound email, does not detect a request for an updated value in a prior outbound email, or does not meet one or both of the authorization conditions described in the method 300, then the system will terminate the datastore update process (operation 216). The system may optionally notify a system administrator of the termination of the process as a tool for identifying unauthorized attempts to tamper with datastore values.

Upon detecting the prior outbound transmission that requested the value, the system may extract the parameter from the inbound transmission (operation 220). In some examples, the system may extract the value by copying the value from the inbound transmission, or simply identify the value and reproduce it in memory. The system may also copy metadata from the inbound transmission that the system may use to properly store the extracted (copied) value in a proper field, data object, or other location in the data store. For example, upon copying or otherwise extracting the value from the inbound email, the system may also store an identifier of the field and/or data object (e.g., using any of the identifiers indicated above) associated with the value. These identifiers may then be used to properly locate the data object and/or field in which to store the received value.

In another example, the value may be extracted from an editable data object previously transmitted in the outbound transmission (operation 224). As described above, in some examples the prior outbound transmission may include an embedded, attached, or otherwise associated editable data object. This editable data object may include sufficient metadata to improve the convenience of datastore updates. For example, the data object may include metadata that identifies an agreement, agreement section, part number, and field from which the data object originates. When a value in the data object is entered and returned to the system via the inbound transmission, the system may automatically detect the metadata so that the value may be extracted and ultimately used to update a proper field in the datastore. In some examples, the data object may also include security tokens or other security features that may be detected so that the system may automatically determines that the authorization level needed to update a data store is met.

One embodiment of an editable data object is that of a table object. The system may detect a table data object by scanning the incoming transmission for straight lines that form a grid. Alternatively, the system may detect a table based on an NLP analysis of text directly 19 identifying the table or text within the transmission that references the table. Once identified, the system may extract data from the table detected in the incoming transmission (operation 220). In some examples, the system may extract values from a particular position in the identified table consistent with positions indicated in the previously sent outbound transmission. The system may also be configured to search a table for certain data formats (e.g., numerical) or formats identified by metadata and extract the values based on the certain formats.

In still another example, a value can be extracted from an electronically scanned written document by executing optical character recognition (OCR) on the electronically scanned document. Once OCR is complete, the techniques described above may be used to identify the value, copy or store a representation of the value in memory.

Once extracted the system may store the value in a proper location as identified by the analyzed metadata (operation 228). That is, the system may use the previously described metadata to identify and select a data object (e.g., a table, sub-table, directory) in the datastore in which to store the value. The system may also use metadata, an editable data object, and/or the previously described machine learning and/or NLP techniques to identify a field in which to store the value. Once the proper location in the data store is identified, the system may update the datastore with the extracted value.

In some examples, the system may update the datastore with the extracted value by comparing columns, rows, or other data provided in a data object in the inbound transmission with similar fields from a data object stored in the datastore. In other embodiments, the system may identify a datastore object to update by searching the datastore using a column header (or multiple column headers) and/or a row header (or multiple row headers) from the inbound transmission to identify a corresponding stored record (or records) within a stored datastore object to be updated. Upon identifying a stored object using the headers as search terms, the system may determine whether the extracted data differs from the stored data. Responsive to determining a difference, the system may replace the existing values with the extracted data values from the transmission(s). In some examples, the system may create a new record in the database using the values extracted from the inbound transmission. The system may generate a new field for a set of records to store values extracted from the inbound transmission.

The preceding description presents examples of the methods 200 and 300 as including one inbound transmission and one corresponding outbound transmission. This focus on pairs of inbound and outbound transmissions is for convenience of description. In some embodiments, the system may analyze multiple inbound transmissions, multiple outbound transmissions, or both, as part of updating a value in a datastore. For example, the system, using a combination of data/time stamps on communications, natural language processing, machine learning, topic extraction, and other techniques, may identify a current request from a series of request and/or a current update from a series of updates, and use only the current request/update transmission pair in the methods 200 and 300. This particular embodiment may be useful when multiple communications are needed to correctly specify a value or correct a mistakenly provided value. Similarly, NLP techniques may identify language in the transmissions that cause the system to disregard some transmissions. For example, “ignore my last communication,” or “use this value and not the previously sent value” and the like may be interpreted by the system, along with date/time stamps, to identify the current transmissions used to update the datastore. This variation is applicable to the following methods 400, 500, and 600 as well.

3.2 EXTRACTING A VALUE FROM A PRIOR OUTBOUND TRANSMISSION UPON IDENTIFYING A VALUE VALIDATION IN AN INBOUND TRANSMISSION

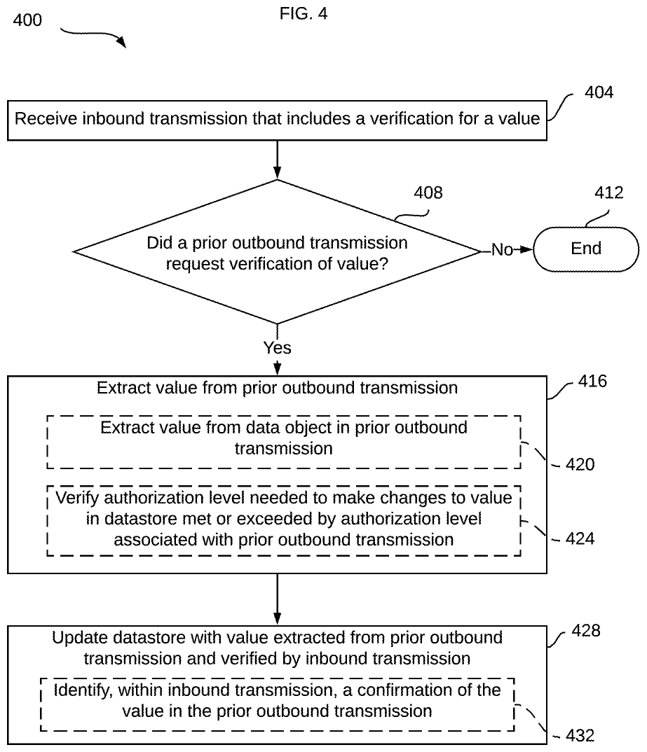

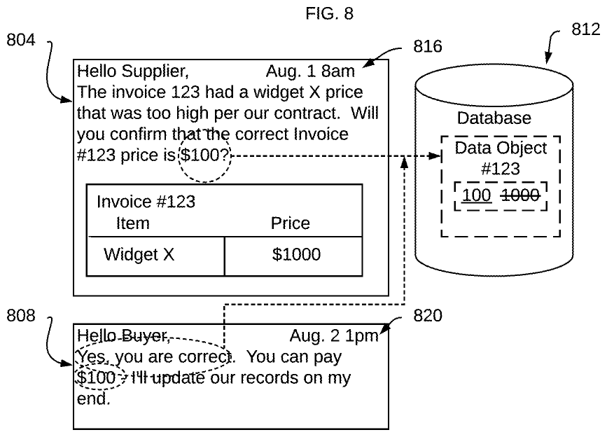

FIG. 4 illustrates example operations in a method 400 that is analogous to the method 200 with the difference that the value used to update a datastore is extracted from a prior outbound transmission instead of the inbound transmission. The extraction and storage of the value from the prior outbound transmission is triggered in response to an inbound transmission verifying the value present in the prior outbound transmission. In addition to the following description in this Section 3.2, a specific example embodiment is presented in FIG. 8 and described in Section 4.

The method 400 may begin in this example with the receipt of an inbound transmission that verifies a value (operation 404). The inbound transmission is analogous to the inbound transmission described in the context of the method 200 and may be any of the transmission types described above. The verification of the value may be identified using a trained machine learning model and natural language processing techniques described above. More generally, the trained machine learning model and natural language processing techniques may recognize and/or identify the presence of a value and language associated with the value that affirms or verifies the value. For illustration, the value and verifying language may appear in a transmission as “Yes, that value is correct,” or simply “correct,” “right,” or “confirmed.”

Upon receiving the inbound transmission with its verification, the system may search for a prior outbound transmission requesting verification of the value (operation 408). Example search techniques for the operation 408 may be analogous to those described above. For example, the system may identify a reference (e.g., any of a variety of identifiers) that is common to both inbound and outbound transmissions. In another example, the system may use a trained machine learning model and/or NLP techniques to identify specific information such as part or service names, field names (corresponding to the value), transmission sources and destinations, date/time stamps, agreement names, and other similar information that may be used to identify the prior outbound transmission that is associated with the inbound transmission. Row and column headers for a table containing may also be used to identify the prior outbound transmission.

If the prior outbound transmission is not identified, then the process 400 ends (operation 412). If the prior outbound transmission is identified, then the value, verified by the inbound transmission, may be extracted from the prior outbound transmission (operation 416). As described above, the value may optionally be extracted from a data object present in the outbound transmission (operation 420). Mediating the validation of a value and the update of the datastore via a data object improves the accuracy and convenience of the process 400 by providing context for the update. That is, by using the data object to convey the value to be validated and the metadata identifying the location in the data store, an agreement identifier, a field identifier, and product/service identifier, the system may more accurately and more efficiently identify the appropriate record(s) in the data store to update with the validated value. Similarly, providing the above metadata with the value enables the source of the inbound transmission to more conveniently locate information used to determine whether a validation should be transmitted.

Alternatively, the system may use a trained machine learning model, NLP techniques, topic extraction, and other techniques described above in the context of the operation 220 to identify the value in the outbound transmission and store the verified value in a proper location in the data store.

Optionally, the system may also verify that the authorization level to make changes to the datastore is met or exceeded by the attributes of the prior outbound transmission, as described above (operation 424).

Once extracted, the data store may extract the value from the prior outbound transmission using the techniques described above in the context of the method 200 (operation 428).

Optionally, the system may identify a confirmation in the inbound transmission of the value initially presented in the prior outbound transmission (operation 432). In other words, the system may not only identify a verification within the inbound transmission that the value was correct in the prior outbound email, but also identify an additional confirmation of the value. This confirmation may be instantiated as a reproduction of the value in the inbound transmission (“You are correct, the value is 5”) or some additional objective indication that improves the confidence level that the value is correct.

3.3 EXTRACTING A VALUE FROM AN INBOUND TRANSMISSION UPON IDENTIFYING REQUIRED AUTHORIZATION LEVELS MET BY TRANSMISSION SOURCE(S)

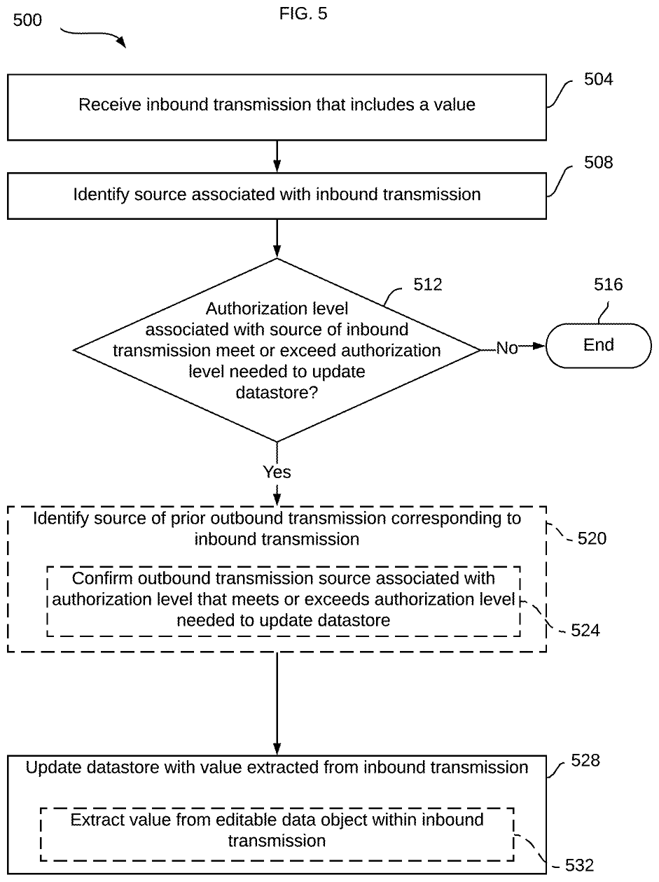

FIG. 5 illustrates an example method 500 that includes a number of operations that are analogous to those described above. However, the method 500 includes additional operations that make updating a value in a datastore contingent upon the inbound transmission meeting a minimum authorization level. The use of an authorization level may be used instead of, or in addition to, the update being contingent upon a prior outbound transmission.

The method 500 begins by receiving an inbound transmission that includes a value (operation 504) and identifying a source associated with the inbound transmission (operation 508). Techniques describing these operations have been described above.

The system then determines whether an authorization level associated with the source of the inbound transmission meets or exceeds an authorization level needed to update the datastore (operation 512). Determining whether this minimum authorization level is met helps preserve the integrity and accuracy of stored data and helps maintain the security of the data store as a whole. As described above, the system may determine whether the minimum authorization level is met based on the source of the inbound transmission being listed on a whitelist, a blacklist, or otherwise being associated with permissions. Other attributes and factors, also described above, may also be used to determine whether the inbound message meets the minimum authorization level.

If the authorization level for updating the datastore is not met, the method is terminated (operation 516). If the authorization level is met, then optionally the system may identify whether a prior outbound corresponding to the inbound message using any of the correlation techniques described above (operation 520). The system may also confirm that the authorization level associated with a source of the outbound transmission meets or exceeds an authorization level needed to update or change values in a datastore (operation 524).

The system may update the datastore with the value extracted from the inbound transmission (operation 528), which may, as described above, include extraction from an editable data object (operation 532).

### 4. GENERATING A NOTIFICATION UPON DETERMINING A DIFFERENCE IN A STORED VALUE AND A VALUE RECEIVED IN AN INBOUND TRANSMISSION

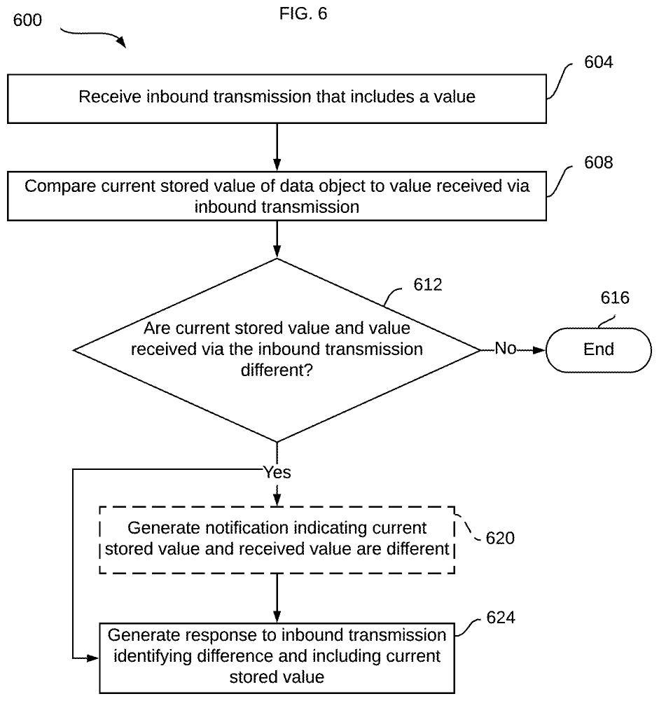

The various techniques for identifying values in inbound and/or outbound transmissions described above need not only be used for updating a datastore. The method 600, illustrated in FIG. 6, includes example operations in which these techniques are applied to protect and/or improve validity and accuracy of data in a datastore.

The method 600 begins by receiving an inbound transmission that includes a value (operation 604). The system then compares the received value to the corresponding value stored in a data store (operation 608). This may be accomplished simply by applying algorithms that test a relative character value (for numeric characters), or generate tokens from alphabetic characters (e.g., words, alphanumeric sequences) so that feature vectors may be generated. The feature vectors may then be compared using a similarity analysis (e.g., cosine similarity) to determine whether the value in the inbound transmission and the stored value are similar or different.

If the system determines that the stored and received values are not different, the method 600 terminates (operation 616). However, if the system determines that the values are different, the system may optionally generate a notification indicating this difference (operation 620). Alternatively, or additionally, the system may generate a response (e.g., using an email client or communication channel in a specialized application) that notifies the source of the inbound transmission of the difference (operation 624). In some examples, the system may extract or copy a data object storing the value and similarly extract or copy the value as presented in the inbound transmission and place them in the response. In this way, the response provides an objective observation of the discrepancy.

### 5. EXAMPLE EMBODIMENTS

A detailed example is described below for purposes of clarity. Components and/or operations described below should be understood as one specific example which may not be applicable to certain embodiments. Accordingly, components and/or operations described below should not be construed as limiting the scope of any of the claims.

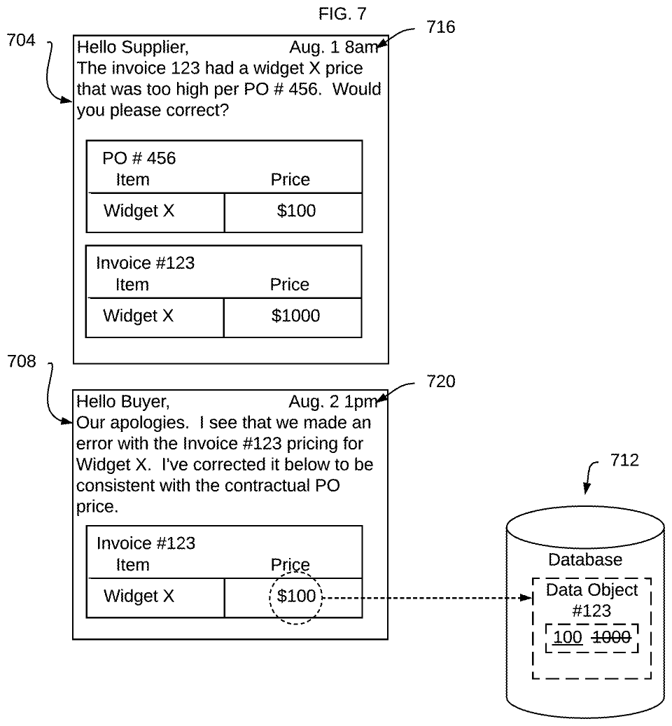

FIG. 7 illustrates an example scenario in which a value extracted from an inbound transmission is associated with a prior outbound transmission and used to update a database. This scenario includes prior outbound transmission 704, inbound transmission 708, and database 712. As indicated, by time/date stamps 716 and 720, the prior outbound transmission 704 preceded the inbound transmission 708. The system may use any number of transmission attributes to associate the prior outbound transmission 704 with the inbound transmission 708. These include the common reference to “Invoice 123” and/or “Widget X” as well as date/time stamps, correspondence addresses (not shown), among other attributes described above. Upon execution of the method 200 (and optionally the method 300), the system extracts the price of $100 from the inbound message 708 and updates a corresponding data object for invoice #123 in the database 712. In this case, the update is illustrated using strikethrough and underline formatting to show the removal of the incorrect value of $1000 and the replacement in the data object with the correct value of $100.

FIG. 8 illustrates an example scenario corresponding to the method 400 in which a value is extracted from a prior outbound transmission 804 upon receipt of a validation and confirmation of the value in an inbound transmission 808. Date/time stamps 816, 820 illustrate that the prior outbound transmission 804 preceded the inbound transmission 808. The language of the prior outbound transmission 804, interpreted by NLP and machine learning techniques described above, indicates an error in the price of Widget X and provides a correct value of $100. The inbound transmission 808 provides a validation of the revised value (“Yes, you are correct”) and a separate confirmation of the specific value (“You can pay $100”). These two increase the confidence level of the accuracy of the update made to the database 812 using the value in the prior outbound transmission 804, indicated using same formatting in FIG. 7.

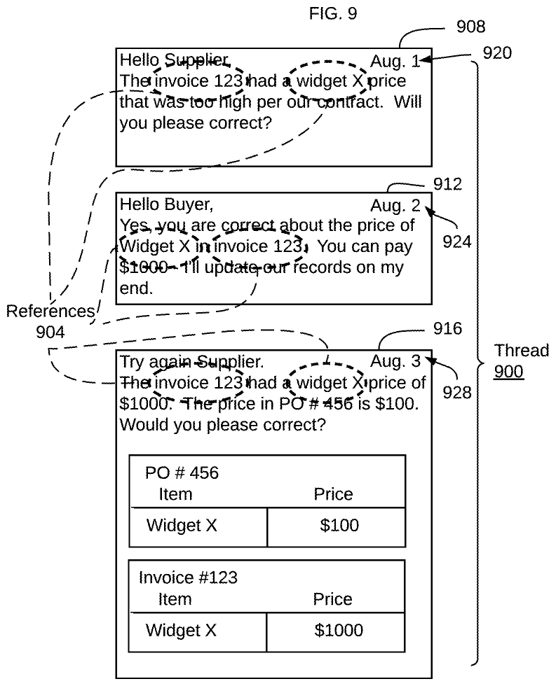

FIG. 9 illustrates an example scenario in which the system collectively analyzes a thread 900 of a series of transmissions 908, 912, 916. As shown, the references 904 to Invoice 123 and Widget X may be identified by the system (using machine learning, NLP, text matching) to identify the three transmissions 908, 912, and 916 as related. The system may then place the communications 908, 912, 916 in order based on a comparison of time/date stamps 920, 924, and 928. Once the most recent transmission is identified and the state of the correspondence determined (in this case, awaiting a confirmation from a supplier of a value provided in an outgoing transmission), any of the various techniques described above may be applied to update a datastore.

### 6. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. MISCELLANEOUS; EXTENSIONS

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 8. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

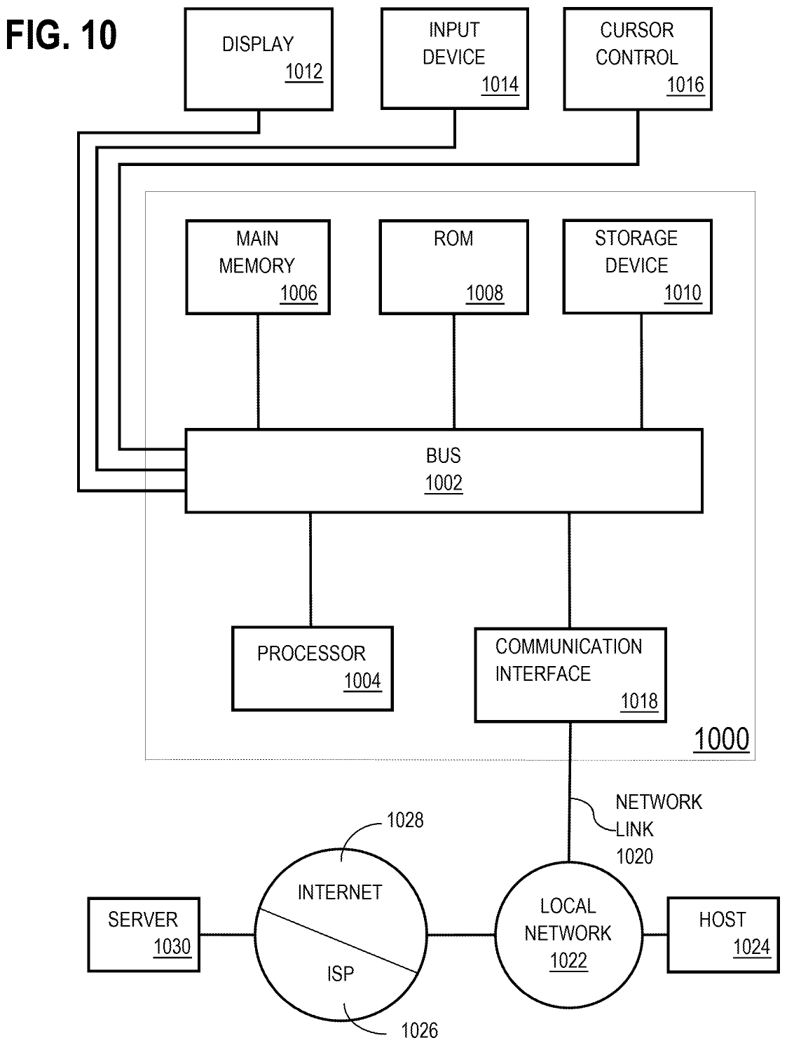

For example, FIG. 10 is a block diagram that illustrates a computer system 1000 upon which an embodiment of the invention may be implemented. Computer system 1000 includes a bus 1002 or other communication mechanism for communicating information, and a hardware processor 1004 coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk or optical disk, is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

31

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory computer-readable media storing instructions, which when executed by one or more hardware processors, cause performance of operations comprising:
receiving an inbound transmission comprising a particular value;
determining whether the inbound transmission corresponds to a prior outbound transmission requesting the particular value;
responsive to determining that the inbound transmission corresponds to the prior outbound transmission requesting the particular value:
extracting the particular value from the inbound transmission;
updating a datastore with the particular value comprised in the inbound transmission.

2. The media of claim 1, further comprising:
identifying a first authorization level associated with the prior outbound transmission;
determining a minimum authorization level needed to update the data store with the particular value; and
responsive to determining the first authorization level meets or exceeds the minimum authorization level, updating the datastore with the particular value comprised in the inbound transmission.

3. The media of claim 2, further comprising:
determining a second authorization level associated with the inbound transmission; and
responsive to determining the second authorization level meets or exceeds the minimum authorization level, updating the datastore with the particular value comprised in the inbound transmission.

4. The media of claim 1, wherein:
the prior outbound transmission comprises an editable data object;
the inbound transmission includes the particular value in the editable data object; and
the particular value is extracted from the editable data object in the inbound transmission.

5. The media of claim 1, wherein determining that the inbound transmission corresponds to a prior outbound transmission requesting the particular value comprises identifying a common reference in both of the inbound transmission and the prior outbound transmission.

6. The media of claim 5, wherein the common reference comprises one or more of an outbound transmission identifier, a data object identifier, a parameter name, or a parameter identifier.

7. One or more non-transitory computer-readable media storing instructions, which when executed by one or more hardware processors, cause performance of operations comprising:
receiving an inbound transmission comprising a data verification for a particular value;
determining whether the inbound transmission corresponds to a prior outbound transmission requesting the data verification for the particular value;
responsive to determining that the inbound transmission corresponds to the prior outbound transmission requesting the data verification for the particular value:
extracting the particular value comprised in the prior outbound transmission;
updating a datastore with the particular value comprised in the prior outbound transmission.

8. The media of claim 7, wherein the updating the datastore with the particular value in the prior outbound transmission is responsive to identifying a confirmation in the inbound transmission confirming the data verification of the particular value.

9. The media of claim 8, wherein:
the prior outbound transmission comprises a data object that includes the particular value;
responsive to identifying the confirmation in the inbound transmission, extracting the particular value from the data object and updating the datastore with the extracted particular value.

10. The media of claim 7, wherein determining that the inbound transmission corresponds to the prior outbound transmission comprises identifying a common reference in both of the inbound transmission and the prior outbound transmission.

11. The media of claim 10, wherein the common reference comprises one or more of an outbound transmission identifier, a data object identifier, a parameter name, or a parameter identifier.

12. The media of claim 7, further comprising:
identifying a first authorization level associated with the prior outbound transmission;
determining a minimum authorization level needed to update the data store with the particular value; and
responsive to determining the first authorization level meets or exceeds the minimum authorization level, updating the datastore with the particular value comprised in the inbound transmission.

13. One or more non-transitory computer-readable media storing instructions, which when executed by one or more hardware processors, cause performance of operations comprising:
receiving an inbound transmission, the inbound transmission including a particular value;
identifying a source of the inbound transmission; and
determining a first authorization level associated with the source;
responsive to determining that the first authorization level associated with the source is above the minimum authorization level needed to update a datastore:
extracting the particular value from the inbound transmission;
updating the datastore with the particular value extracted from the inbound transmission.

14. The media of claim 13, further comprising determining that the inbound transmission corresponds to a prior outbound transmission requesting the particular value.

15. The media of claim 14, further comprising:
identifying an outbound source of the prior outbound transmission;
determining that the outbound source of the prior outbound transmission is associated with a second authorization level;
determining that both the first authorization level and the second authorization level are above the minimum authorization level needed to update a datastore prior to the extracting and updating operations.

16. The media of claim 14, wherein determining that the inbound transmission corresponds to a prior outbound transmission comprises identifying a common reference in both of the inbound transmission and the prior outbound transmission.

17. The media of claim 13, wherein:
the inbound transmission comprises an editable data object that includes the particular value in the editable data object; and
the extracting operation comprises extracting the particular value from the editable data object in the inbound transmission.

18. One or more non-transitory computer-readable media storing instructions, which when executed by one or more hardware processors, cause performance of operations comprising:
receiving an inbound transmission comprising a received value for a data object stored in a datastore;
comparing a current value of the data object stored in the datastore to the received value for the data object comprised in the inbound transmission;
responsive to determining that the received value and the current value are different, performing one or more of:
(a) generating a notification indicating that the received value and the current value are different;
(b) generating a response transmission indicating that the received value and the current value are different, the response transmission including the current value of the data object.

19. The media of claim 18, wherein the inbound transmission comprises a data object that includes the received value.

20. The media of claim 18, wherein one or more of the notification and the response transmission further comprises a portion of the inbound transmission comprising the received value for the data object.
